(19) United States
(12) Patent Application Publication
(10) Pub. No.: US 2011/0204836 A1
(43) Pub. Date: Aug. 25, 2011

(54) SHAFT ROTATOR FOR STORED EQUIPMENT WITH ANTI-FRICTION BEARINGS

(75) Inventor: GLENN LEWIS KLING, WILMINGTON, NC (US)

(73) Assignee: GLENN LEWIS KLING, Wilmington, NC (US)

(21) Appl. No.: 12/709,477

(22) Filed: Feb. 20, 2010

(51) Int. Cl. H02P 7/00; H02K 7/116

(52) U.S. Cl. 318/445; 310/83

(57) ABSTRACT

Invention rotates the shaft of stored and/or stand-by rotating equipment to intervene in the false brinelling and/or lubricant separation process, thus eliminating and/or minimizing the subsequent premature bearing failure when the equipment is placed in service.

### FEDERALLY SPONSORED RESEARCH OR DEVELOPMENT

None

### MATERIAL SUBMITTED SEPARATELY ON COMPACT DISC

None

### BACKGROUND OF INVENTION

In an industrial setting, stored equipment is frequently a critical spare. When an on-line unit fails, the performance of its replacement becomes crucial since the premature failure of the spare can easily lead to long-term loss of manufacturing capability. Bearing failures in stored spares, however, is not uncommon.

When equipment with anti-friction bearings is transported, stored, or is on stand-by, the anti-friction bearings are especially susceptible to developing defects that compromise their on-line life. These defects include false brinelling and/or grease separation and/or loss of the protective lubrication film. If not caught in their infancy, these defects develop into failure modes. Taken in concert or individually, they cause the bearing to fail rapidly when the equipment is placed in service. These defects are described in greater detail below.

False Brinelling:
When equipment shafts are stationary, point loading is confined to the same bearing contact area. This loading is multiplied by the accelerations associated with vibrations and longitudinal movements normally found in transportation, storage, and industrial environments. Over a period of time, this vibration-amplified point loading results in false brinelling (unintentional and excessive metal hardening) at the contact area with an associated depression in the metal at the contact area. When the equipment is brought on line, the over-hardened spot either pops out of the parent metal or the depression damages other bearing components on each revolution. In either case, bearing failure is accelerated. Rotating the bearings on some frequency interrupts the false brinelling.

Lubricant Separation:
The grease commonly used in anti-friction bearings consists of oil that is mixed with a soap to form a solid. However, if the mixture is allowed to stand stagnant over time, as in a stationary bearing, the oil and soap tend to separate. When the equipment is brought on line, the oil/base separation results in inadequate lubrication, leading to premature bearing failure. Rotating the bearings on some frequency maintains the oil/soap mixture.

Lubrication Film Failure:
When anti-friction bearings sit in the same position over a period of time, the original lubrication film that separated the rolling member from the race is squeezed out. This same film protects the polished steel components from moisture, and when lost, corrosion results. When equipment is brought on line, the bearing suffers immediate and irreparable damage until the lubrication film can be reestablished. Even when reestablished, the lubricant picks up the particles of damaged metal, along with any corrosive particles, and forms a grinding paste, accelerating bearing failure. Rotating the bearings on some frequency maintains the protective film.

To eliminate and/or minimize these failure modes, bearings must be rotated on some frequency, normally by rotating the shaft(s) upon which they are mounted. Rotating the shaft relocates the load contact area, remixes the grease, and renews the lubrication film.

Rotating stored equipment on some frequency requires the assignment of resources to establish a schedule, train employees, audit the actual turning of the shafts, and maintain value for the program. Over a period of time, however, personnel changes and requirements to cut costs frequently target programs that don't have short-term impact on costs. Labor-intensive shaft rotation schedules falls into this category.

The Shaft Rotator:
Resolves the stationary bearing issue, the root cause of false brinelling, grease separation, and loss of lubrication film
May be applied at equipment's point of manufacture so bearings are protected from the time of original installation in equipment through the time the equipment is brought on line, interrupting the defect cycle before it can begin
Is cost effective, establishing a sustainable, long-term bearing performance system for minimal investment

### SUMMARY OF INVENTION

The invention provides automated shaft rotation for equipment with anti-friction bearings, for instance, electric motors. This automated rotation intervenes in the causes of bearing failure: false brinelling, lubricant separation, and loss of lubrication film. If applied at point of equipment manufacture, the failure causes never gain a foothold. The Shaft Rotator is cost-effective, labor-adverse, and on going.

### DESCRIPTION OF SEVERAL VIEWS OF DRAWINGS

FIG. 1 is a sectional view through the center of the Shaft Rotator

FIG. 2 is a view from the control end of the Shaft Rotator

FIG. 3 is a top view of the Shaft Rotator

FIG. 4 is a view from the attachment end of the Shaft Rotator

FIG. 5 is a sectional view through the center of the Torque Arm

FIG. 6 is a view of the Weight

### DESCRIPTION OF COMPONENTS

1—Outer Case
2—Reinforcement Bushing
3—Drive Cog
4—Inner Case
5—Bearing
6—Power Unit
7—Power Box Base
8—Power Box Seal
9—Power Box Cover
10—Input Power Wiring
11—Output Power Wiring
12—Case Seal
13—Electronic Control Unit
14—Torque Arm
15—Clamp
16—Retainer
17—Power Box Plug
18—Weight

### DETAILED DESCRIPTION OF INVENTION

### Preferred Embodiment

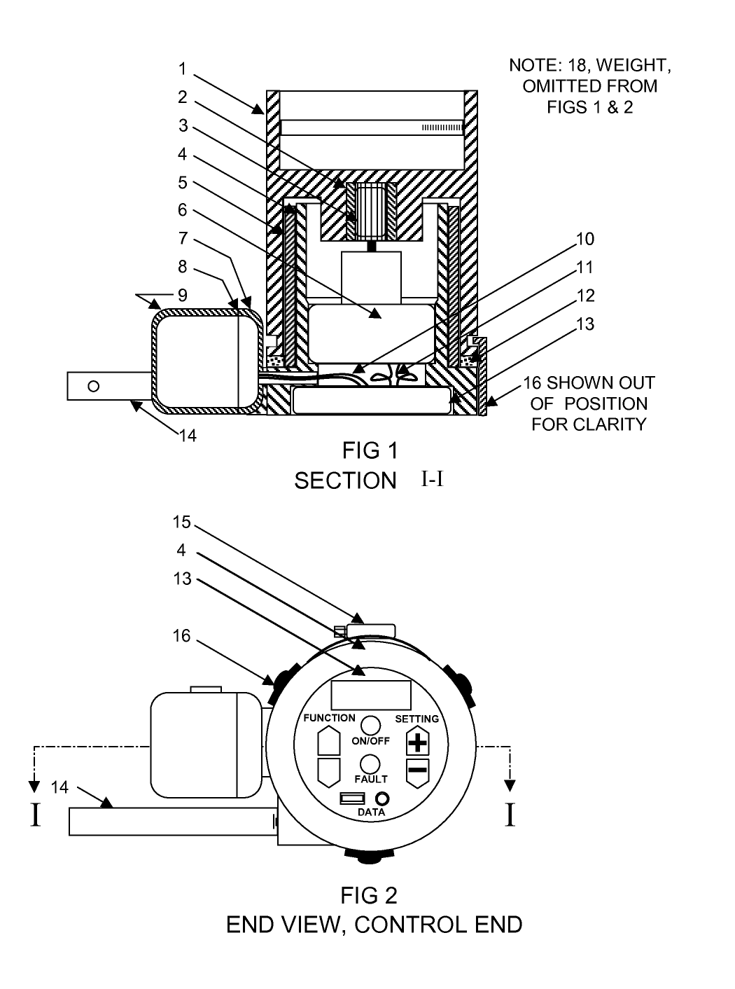

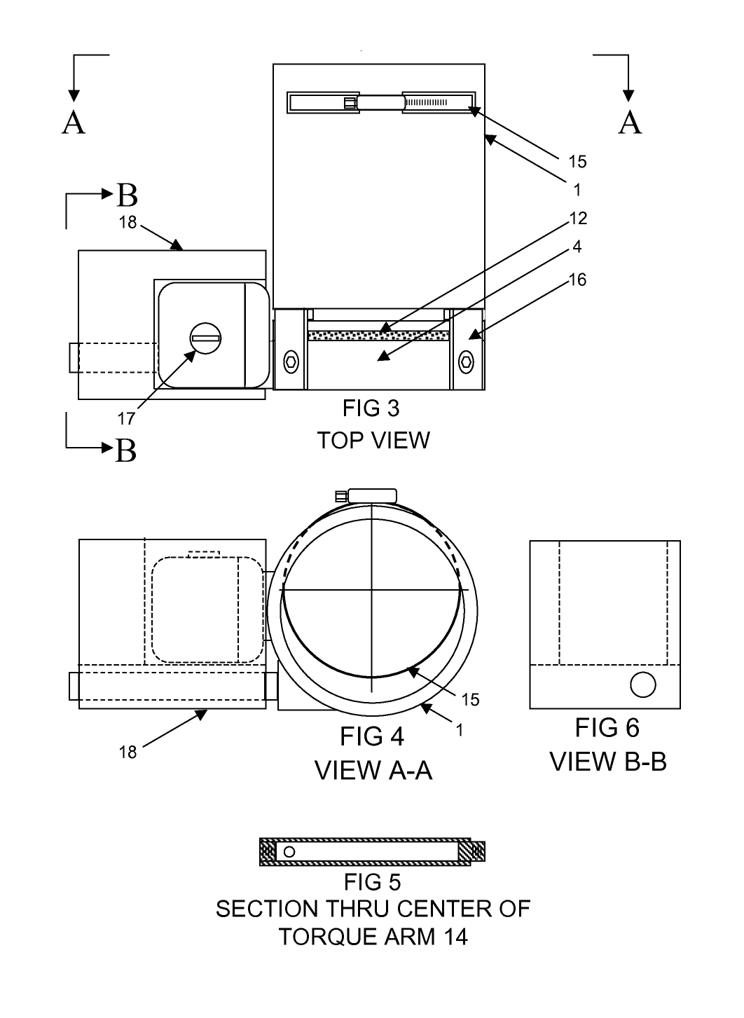

Installation:
Referring to FIG. 4, the operator installs the Shaft Rotator by sliding it over the equipment shaft, allowing the shaft to slide through Clamp 15 until it bottoms out inside Outer Case 1. Clamp 15 is then tightened sufficiently to fix the Shaft Rotator to the equipment shaft.
Power Source:
Depending on the power source, the operator either:
   A. Referring to FIG. 1, installs a battery:
      Removes Power Box Cover 9
      Installs battery
      Reinstalls Power Box Cover 9 upon the Power Box Base 7, taking care to ensure Power Box Seal 8 is installed correctly
   Or
   B. Referring to FIG. 3, attaches to the utility power supply:
      Removes Power Box Plug 17
      Installs commercially available cable connection in place of Power Box Plug 17
      Attaches drop cord or permanent cable
      Provides electricity to Shaft Rotator by connecting to electrical receptacle or power panel
   Or
   C. Referring to FIG. 1, winds up the internal spring using a wind-up key through an access hole in the blank plate that replaces Electronic Control Unit 13 when a spring Power Unit 6 is used in place of a electrical Power Unit 6.

Torque Setting: Refer to FIG. 1, except as noted:

If used on unattached motors, the weight of the battery will normally provide adequate torque to turn the equipment shaft. If the equipment requires a higher turning torque, Weight 18 (FIG. 3) may be installed. If maximum torque is required, Torque Arm 14 is installed and its movement restricted, thus restricting the rotation of Inner Case 4. When operated, Inner Case 4 rotates within Bearing 5 until the equipment shaft rotates or Torque Arm 14 reaches its point of restriction. Additional Torque Arms 14 may be screwed end-on-end to extend the torque arm as needed for a particular application.

The Shaft Rotator is now ready to be placed in operation as detailed below.

Electrically Operated (Battery or Utility): Refer to FIG. 1
The operator presses the on/off button on the Electronic Control Unit 13, powering up the Shaft Rotator.
Using the Function buttons, the operator selects manual or automatic operation.
If manual, the Shaft Rotator counts down for 30 seconds and then begins rotating for 60 seconds. The unit continues to cycle on a pre-set interval unless interrupted by a fault as noted below.
If automatic is selected, the operator then selects the interval of operation (hours), length of operation (seconds), and fault indication (audible and/or visual) after which the Shaft Rotator counts down for 30 seconds and then initiates the first cycle.
Once the Shaft Rotator counts down in either manual or automatic mode, the control unit activates the Power Unit 6, causing Drive Cog 3 to turn Reinforcing Bushing 2 which transmits torque to Outer Case 1.
The equipment shaft restricts Outer Case 1 from initially rotating, causing Inner Case 4 to begin rotating in the opposite direction within Bearing 5. Inner Case 4 rotates until the weight of the battery in Power Box Cover 9 or Weight 18 or Torque Arm 14 causes Outer Case 1 and equipment shaft to which it is attached to rotate in the opposite direction of Inner Case 4, allowing Inner Case 4 to move back towards its initial position.
If the equipment requires low torque to rotate it, the weight of the battery in Power Box Cover 9 will cause the equipment shaft to rotate. If the equipment requires a higher rotating torque, it will begin rotating when Torque Arm 14 reaches the point of restriction at 90 degrees.
If Inner Case 4 rotates over 90 degrees from horizontal, a level switch contained within Electronic Control Unit 13 will stop Power Unit 6 until the equipment shaft rotates, allowing Inner Case 4 to rotate back towards horizontal and less than 90 degrees, at which time Power Unit 6 restarts. If the level switch does not reset below 90 degrees in an allocated time, this indicates that rotation of the equipment shaft has not occurred. This fault will activate a visual and/or audible indicator on Electronic Control Unit 13.
If Torque Arm 14 is used and Electronic Control Unit 13 detects a high current for Power Unit 6 for a certain amount of time, this indicates that rotation of the equipment shaft has not occurred. The fault will be indicated by a visual and/or audible signal on the face of Electronic Control Unit 13.
The Shaft Rotator's Electronic Control Unit 13 records the details of the operation (date, length of cycle, OK or Fault)
The operator can retrieve the stored data from Electronic Control Unit 13 at his/her leisure with cord, wireless, or infrared
If the Shaft Rotator faults, the fault signal (audible and/or visual) will engage and alert in allocated time cycles until operator responds. Fault data is recorded and available for retrieval.
If the Shaft Rotator does not fault, the operation cycle will continue. If on battery, when the battery voltage drops to a pre-set level, the audible and/or visual alarm will alert the operator, however, operation will continue on the pre-set cycle. If battery is not replaced, operation will stop but alarm(s) will continue.

Spring Operated:
Spring operation is similar to Electrical Operation except the first cycle begins after the spring is fully wound and the operator engages the mechanical trip causing the mechanism to start.
The interval of operation and length of operation are non-adjustable and there is no recorded data.
The operator rewinds the spring on a set cycle.

Other Features:
Referring to FIG. 1, the Case Seal 12 is replaceable as needed.
Referring to FIG. 1, Input Power Wiring 10 conducts the power from the battery or utility to Electronic Control Unit 13.
Referring to FIG. 1, Output Power Wiring 11 conducts the control power from the Electronic Control Unit 13 to the Power Unit 6.
Referring to FIG. 3, Retainer 16, of which there are three each, maintains the alignment between the Outer Case 1 and Inner Case 4.
Referring to FIG. 1, an input torque-limiting device is built into Power Unit 6 to ensure the operator applying excessive input torque cannot damage the Shaft Rotator.

What is claimed is:

1. A Shaft Rotator, comprised in combination:
1. An outer case containing a
a. Bearing to enable the outer case to rotate about the inner case
b. Reinforcing bushing to transmit torque
c. Clamp to attach the shaft rotator's case to the rotated equipment's shaft
2. An inner case containing a:
a. Power unit to provide the rotational torque, comprised in combination:
Motor [battery operated, utility power operated (international voltages and frequencies), or wind-up spring]
Gearbox to achieve required output rpm and increase output torque
Clutch to limit input torque to eliminate possibility of damaging gearbox from inappropriate operator action
Drive cog to transmit output torque from power unit to reinforcing bushing in outer case
Mechanical pawl to control wind-up motor on/off operation; electric motors controlled by electronic control unit as described below
b. Power box comprised in combination:
Base to which the electric energy source is connected. The source may be battery or utility power in combination with a voltage-reducing power supply or full voltage
Seal between base and cover to separate environment within case from environment outside of case
Cover to protect and retain battery or voltage-reducing power supply to base or serve as a junction box to attach utility power cord
Plug(s) in cover, that when removed, provides a port for the utility power cord
c. Electronic control unit physically containing electronics, hardware, read-out display, indicators (visible and audible), operator interface control buttons, communications ports (wired, wireless, and/or infrared), internationally recognized symbols, and input/output wiring
d. Electronic control unit functionally containing in combination:
Rotation fault detection: Angle of rotation sensing switches and current sensing devices along with software required for sensing rotation, analyzing data, controlling electric motor, and storing data for retrieval by operator
Communication technologies: wired, wireless, and/or infrared
Components that allow operation on a range of direct current voltages
Components that allow operation on multiple international utility voltages and frequencies, with automatic and/or manual transition
Components that allow selection of units (U.S., metric), current detection, current limiting, automatic current overload reset for certain amount of cycles, manual current overload reset after automatic cycle, angle-of-rotation detection function, Test/Reset, variable “On” time, variable “Off” time, reversible, variable speed, manual or automatic cycle, historical data collection [date(s) of operation, interval(s) of operation, total operation time, outcome of operation (normal/fault)], data storage method and data retrieval methods (corded, wireless, infrared), fault notification (visual and/or audible), power remaining status
e. Electronic control panel configuration including operator interface control buttons, back-lighting (auto-off), read-out (size, lines of text, type), data ports, mounting, input/output wiring
f. Electrical insulation to meet double insulated specifications for safe use in wet locations when using utility power
g. Replacement panel for electronic control panel when spring motor is used, said panel containing a wind-up access port and a lever that controls the on/off mechanism for the spring motor, and a key for winding spring
h. A seal between the outer case and inner case to separate the environment within the cases from the environment outside the cases and other similar seals to achieve dust proof, moisture proof, and explosion proof certifications
i. Retainers that maintain alignment of the inner and outer cases to one another and provide a means of maintenance access
j. Torque arm(s) to increase the torque transmitted to the equipment's shaft
k. Miscellaneous internal wiring to conduct the input power to the electronic control unit and the control power from the electronic control unit to the power unit
3. Materials of construction such as polymers, aluminum, brass, plastics, stainless steels, as required to be robust in industrial applications including environments that are corrosive, dusty, wet, damp, hot, and/or cold.
